(19) United States
(12) Patent Application Publication
(10) Pub. No.: US 2026/0168710 A1
(43) Pub. Date: Jun. 18, 2026

(54) VALVE ASSEMBLY AND A HEAT PUMP SYSTEM INCLUDING THE SAME

(71) Applicants: HYUNDAI MOTOR COMPANY, Seoul (KR); KIA CORPORATION, Seoul (KR); HYUNDAI WIA CORPORATION, Changwon-si (KR)

(72) Inventors: Yeon Ho Kim, Hwaseong-si (KR); Hochan An, Hwaseong-si (KR); Jeawan Kim, Hwaseong-si (KR); Gwi Taek Kim, Hwaseong-si (KR); Man Hee Park, Hwaseong-si (KR); Yeong Jun Kim, Hwaseong-si (KR); Jae Yeon Kim, Hwaseong-si (KR); Hoyoung Jeong, Hwaseong-si (KR); Kwang Seok Lee, Uiwang-si (KR); Jun Ho Kim, Uiwang-si (KR)

(73) Assignees: HYUNDAI MOTOR COMPANY, Seoul (KR); KIA CORPORATION, Seoul (KR); HYUNDAI WIA CORPORATION, Changwon-si (KR)

(21) Appl. No.: 19/263,136

(22) Filed: Jul. 8, 2025

(30) Foreign Application Priority Data
Dec. 12, 2024 (KR) 10-2024-0184380

(51) Int. Cl. F25B 41/26; F16K 11/056

(52) U.S. Cl. CPC F25B 41/26; F16K 11/056

(57) ABSTRACT

A valve assembly includes a valve housing including: a bottom housing port, and a first housing port to a third housing port, respectively formed on sides of the valve housing; and a valve body rotatably disposed within the valve housing and including a bottom body port, a side body port fluidly connected to the bottom body port, and a first expansion groove and a second expansion groove formed adjacent to the side body port. In particular, the bottom body port and the bottom housing port are constantly and fluidly connected. Based on rotation of the valve body, the side body port is selectively and fluidly connected to at least one of the first to third housing port, and the side body port is selectively and fluidly connected to one of the first to the third housing port through the first expansion groove or the second expansion groove.

### CROSS-REFERENCE TO RELATED APPLICATION

This application claims priority to and the benefit of Korean Patent Application No. 10-2024-0184380, filed with the Korean Intellectual Property Office on Dec. 12, 2024, the entire contents of which are incorporated herein by reference.

### BACKGROUND

### (a) Field

The present disclosure relates to a valve assembly and a heat pump system including the same, and more particularly, t a valve assembly capable of implementing multiple valve functions within a heat pump system.

### (b) Description of the Related Art

In general, an air conditioning system for a vehicle includes an air conditioning device that circulates a refrigerant in order to heat or cool the interior of the vehicle.

The air conditioning device maintains a comfortable indoor environment by maintaining the vehicle's indoor temperature at an appropriate level regardless of external temperature changes, and is configured to heat or cool the interior of the vehicle through heat-exchange by an evaporator, while a refrigerant discharged by operation of a compressor circulates back to the compressor through a condenser, a receiver dryer, an expansion valve, and the evaporator.

For example, in the summer cooling mode, the air conditioning device decreases the indoor temperature and humidity through evaporation in the evaporator through the receiver dryer and expansion valve after a high temperature and high pressure gas refrigerant compressed by the compressor is condensed through the condenser.

Nowadays, as interest in energy efficiency and environment pollution increases, development of environmentally-friendly vehicles that can substantially replace internal combustion engine vehicles is requested. Such environmentally-friendly vehicles are generally classified into electric vehicles, which use fuel cells or electricity as a power source, and hybrid vehicles, which use both an engine and an electric battery.

In the electric vehicle among these environmentally-friendly vehicles, a separate heater is not used as in conventional vehicles. Instead, an air conditioner or an air conditioning system used in the electric vehicle is generally referred to as a heat pump system.

In the case of the electric vehicle, a plurality of heat exchangers (condensers, evaporators, etc.) are applied for an indoor air conditioning, a battery cooling, and/or a drive motor cooling, and a plurality of expansion valves are required to supply the expanded refrigerant to these heat exchangers.

Applying a plurality of expansion valves to the heat pump system complicates the configuration of the entire system and increases manufacturing costs.

The above information disclosed in this Background section is only for enhancement of understanding of the background of the disclosure and therefore it may contain information that does not form the prior art that is already known to a person of ordinary skill in the art.

### SUMMARY

The present disclosure provides a valve assembly capable of simultaneously controlling a plurality of heat exchangers through a housing port capable of expanding a refrigerant, and a heat pump system including the same.

In addition, the present disclosure simplifies the structure of the heat pump system and reduces a manufacturing cost.

According to an embodiment of the present disclosure, a valve assembly includes: a valve housing including a bottom housing port, and a first housing port to a third housing port respectively formed on side surfaces of the valve housing; and a valve body rotatably disposed an inside of the valve housing and including a bottom body port, a side body port fluidly connected to the bottom body port, and a first expansion groove and a second expansion groove formed adjacent to the side body port. In particular, the first housing port, the second housing port, and the third housing port are arranged in a circumferential layout around the valve body, and the bottom body port and the bottom housing port may be constantly and fluidly connected to each other. Based on the rotation of the valve body, the side body port may be selectively and fluidly connected to at least one of the first housing port, the second housing port or the third housing port, and the side body port may be selectively and fluidly connected to one of the first housing port, the second housing port and the third housing port through the first expansion groove or the second expansion groove.

In some embodiments, the bottom body port may be formed at the bottom part of the valve body, the side body port may be arranged perpendicular to the bottom body port and is formed along the circumferential direction of the valve body by a predetermined length, the first expansion groove may be formed adjacent to a first side of the side body port of the circumferential direction, and the second expansion groove may be formed adjacent to a second side of the side body port of the circumferential direction.

In some embodiments, the circumferential direction length of the side body port may be formed to correspond to the sum of the circumferential direction lengths of the first housing port and the second housing port, and the circumferential direction lengths of the second housing port and the third housing port.

In some embodiments, the first expansion groove and the second expansion groove may have the same shape.

In some embodiments, the first expansion groove and the second expansion groove may be formed to have identical lengths, widths, and depth gradients.

In some embodiments, the first housing port and the second housing port may be arranged at a predetermined angle in the circumferential direction, and the second housing port and the third housing port may be arranged at a predetermined angle in the circumferential direction.

In some embodiments, the predetermined angle by which the first housing port and the second housing port are spaced apart in the circumferential direction may be equal to the predetermined angle by which the second housing port and the third housing port are spaced apart in the circumferential direction.

In some embodiments, the predetermined angle by which the first housing port and the second housing port are spaced apart in the circumferential direction, and the predetermined angle by which the second housing port and the third housing port are spaced apart in the circumferential direction may be each 90 degrees.

According to an embodiment, a heat pump system includes: a valve housing including a bottom housing port, and a first housing port to a third housing port, which are formed on side surfaces of the valve housing; a valve body rotatably disposed within the valve housing and including a bottom body port, a side body port fluidly connected to the bottom body port, and a first expansion groove and a second expansion groove formed adjacent to the side body port; a first refrigerant line to a third refrigerant line, which are fluidly connected to the first housing port to the third housing port, respectively; and a fourth refrigerant line fluidly connected to the bottom housing port of the valve housing. In particular, the side body port is selectively and fluidly connected to at least one of: the first housing port and the first refrigerant line; the second housing port and the second refrigerant line; and the third housing port and the third refrigerant line. The bottom body port is constantly and fluidly connected to the bottom housing port and the fourth refrigerant line.

In some embodiments, one of a first mode, a second mode, a third mode, a fourth mode, a fifth mode and a sixth mode may be determined for operating based on the rotation of the valve body. The first mode may be a mode in which the refrigerant flowing into the first refrigerant line is discharged into the fourth refrigerant line, and the second mode may be a mode in which some of the refrigerant flowing into the first refrigerant line is expanded and discharged into the second refrigerant line, and the remaining refrigerant flowing into the first refrigerant line is discharged into the fourth refrigerant line. The third mode may be a mode in which the refrigerant flowing into the first refrigerant line is discharged to the second refrigerant line and the fourth refrigerant line, and the fourth mode may be a mode in which some of the refrigerant flowing into the third refrigerant line is expanded and discharged into the second refrigerant line, and the remaining refrigerant flowing into the third refrigerant line is discharged into the fourth refrigerant line. The fifth mode may be a mode in which the refrigerant flowing into the third refrigerant line is discharged to the second refrigerant line and the fourth refrigerant line, and the sixth mode may be a mode in which the refrigerant flowing into the third refrigerant line is discharged into the fourth refrigerant line.

In some embodiments, the valve body is positioned at a reference position in the first mode, and the valve body is rotated by a first predetermined angle in a predetermined direction from the reference position in the second mode. The valve body is rotated by a second predetermined angle in a predetermined direction from the reference position in the third mode, and the valve body is rotated by a third predetermined angle in a predetermined direction from the reference position in the fourth mode. The valve body is rotated by a fourth predetermined angle in a predetermined direction from the reference position in the fifth mode, and the valve body is rotated by a fifth predetermined angle in a predetermined direction from the reference position in the sixth mode.

In some embodiments, in the first mode, the first refrigerant line may be fluidly connected to the fourth refrigerant line through the first housing port, the side body port, the bottom body port, and the fourth housing port, and the refrigerant flowing through the first refrigerant line may be discharged to the fourth refrigerant line.

In some embodiments, in the second mode, the first refrigerant line may be fluidly connected to the fourth refrigerant line through the first housing port, the side body port, the bottom body port, and the fourth housing port, and the first refrigerant line may be fluidly connected to the second refrigerant line through the first housing port, the side body port, the first expansion groove, and the second housing port, and a portion of the refrigerant that inflows into the first refrigerant line may be discharged into the fourth refrigerant line, and the remaining refrigerant that flows into the first refrigerant line may expand through the first expansion groove and be discharged into the second refrigerant line.

In some embodiments, in the third mode, the first refrigerant line may be fluidly connected to the fourth refrigerant line through the first housing port, the side body port, the bottom body port, and the bottom housing port, the first refrigerant line may be fluidly connected to the second refrigerant line through the first housing port, the side body port, and the second housing port, a portion of the refrigerant that inflows into the first refrigerant line may be discharged into the fourth refrigerant line, and the remaining refrigerant that flows into the first refrigerant line may be discharged into the second refrigerant line.

In some embodiments, in the fourth mode, the third refrigerant line may be fluidly connected to the fourth refrigerant line through the third housing port, the side body port, the bottom body port, and the bottom housing port, the third refrigerant line may be fluidly connected to the second refrigerant line through the third housing port, the side body port, and the second housing port, a portion of the refrigerant that flows into the third refrigerant line may be discharged into the fourth refrigerant line, and the remaining refrigerant that flows into the third refrigerant line may be discharged into the second refrigerant line.

In some embodiments, in the fifth mode, the third refrigerant line may be fluidly connected to the fourth refrigerant line through the third housing port, the side body port, the bottom body port, and the bottom housing port, the third refrigerant line may be fluidly connected to the second refrigerant line through the third housing port, the side body port, the second expansion groove, and the second housing port, a portion of the refrigerant that inflows into the second refrigerant line may be discharged into the fourth refrigerant line, and the remaining refrigerant flowing into the second refrigerant line may expand through the second expansion groove and be discharged into the second refrigerant line.

In some embodiments, in the sixth mode, the third refrigerant line may be fluidly connected to the fourth refrigerant line through the third housing port, the side body port, the bottom body port, and the bottom housing port, and the refrigerant flowing into the third refrigerant line may be discharged into the fourth refrigerant line.

In an embodiment, a valve assembly for a heat pump system includes: a valve housing including: a bottom housing port, and a first housing port, a second housing port and a third housing port, which are respectively formed on side surfaces of the valve housing; and a valve body rotatably disposed within the valve housing and including: a bottom body port, a side body port fluidly connected to the bottom body port, and a first expansion groove and a second expansion groove formed adjacent to the side body port, wherein the bottom body port and the bottom housing port are constantly and fluidly connected to each other. In particular, based on rotation of the valve body, the side body port is selectively and fluidly connected to at least one of the first housing port, the second housing port or the third housing port, and the side body port is selectively and fluidly connected to one of the first housing port, the second housing port and the third housing port through the first expansion groove or the second expansion groove.

According to embodiments, the functions of the refrigerant discharge and the expansion valve may be implemented through the single valve assembly, thereby simplifying the structure of the heat pump system to which the valve assembly is applied, and reducing a manufacturing cost.

Further, effects that can be obtained or expected from exemplary embodiments of the present disclosure are directly or suggestively described in the following detailed description. That is, various effects expected from exemplary embodiments of the present disclosure will be described in the following detailed description.

### BRIEF DESCRIPTION OF THE DRAWINGS

The drawings are provided for reference to explain illustrative embodiments of the present disclosure, and the technical spirit of the present disclosure should not be interpreted to be limited to the accompanying drawings.

FIG. 1 and FIG. 2 are perspective views illustrating a configuration of a valve assembly according to an embodiment.

FIG. 3 is a partially cut-away perspective view illustrating a configuration of a valve assembly according to an embodiment.

FIG. 4 is an exploded perspective view of a valve assembly according to an embodiment.

FIG. 5 and FIG. 6 are perspective views illustrating a configuration of a valve body according to an embodiment.

FIG. 7 is a cutaway perspective view illustrating a configuration of a valve body according to an embodiment.

FIG. 8 is a cross-sectional view illustrating a configuration of a valve body according to an embodiment.

FIG. 9 to FIG. 14 are diagrams illustrating operation states of a valve assembly according to an embodiment.

The drawings referenced above are not necessarily drawn to scale and are to be understood as presenting rather simplified representations of various preferred features that illustrate basic principles of the present disclosure. Certain design features of the present disclosure, including, for example, particular dimensions, directions, positions, and shapes will be determined in part by particular intended applications and use environments.

### DETAILED DESCRIPTION

The terminology used herein is for the purpose of describing particular embodiments only, and is not intended to limit the present disclosure. As used herein, singular forms are intended to also include a plurality of forms, unless the context clearly indicates otherwise. It should be further understood that term “comprises” or “have” used in the present specification specify the presence of stated features, numerals, steps, operations, components, parts, or a combination thereof, but does not preclude the presence or addition of one or more other features, numerals, steps, operations, components, parts, or a combination thereof. Also, as used herein, the term “and/or” includes any plurality of combinations of items or any of a plurality of listed items.

The present disclosure is described more fully hereinafter with reference to the accompanying drawings, in which some embodiments of the disclosure are illustrated. As those having ordinary skill in the art would realize, the described embodiments may be modified in various different ways, all without departing from the spirit or scope of the present disclosure.

Descriptions of parts not related to the present disclosure are omitted, and like reference numerals designate like elements throughout the specification.

Further, since sizes and thicknesses of constituent members shown in the accompanying drawings are arbitrarily given for better understanding and ease of description, the present disclosure is not limited to the illustrated sizes and thicknesses, and the thickness is enlarged to clearly express various parts and regions.

The terms “module” and “unit” for components used in the following description are used only in order to easily make a specification. Therefore, these terms do not have meanings or roles that distinguish them from each other in themselves.

Further, in describing embodiments of the present specification, when it is determined that a detailed description of the well-known art associated with the present disclosure may obscure the gist of the present disclosure, it has been omitted.

In addition, the accompanying drawings are provided to facilitate understanding of the embodiments disclosed in the present specification and are not to be construed as limiting the scope or spirit of the present disclosure, and it is to be understood that the present disclosure includes all modifications, equivalents, and substitutions without departing from the scope and spirit of the present disclosure.

Terms including ordinal numbers such as first, second, and the like are used only to describe various components, and are not interpreted as limiting these components.

In the explanations below, expressions written in the singular may be interpreted as either singular or plural, unless explicit expressions such as “one” or “singular” are used. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

The terms are only used to differentiate one component from other components.

Below, a valve assembly according to an embodiment is described in detail with reference to attached drawings.

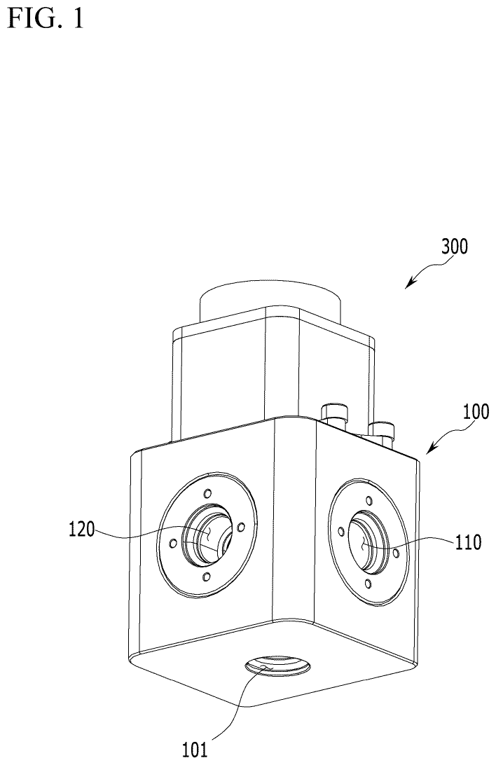

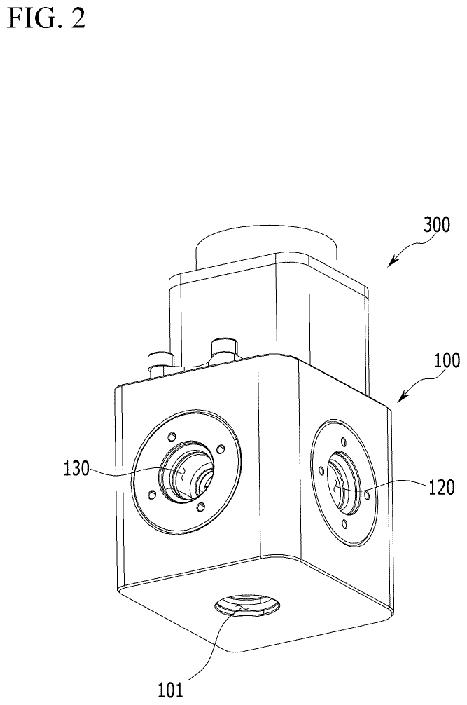

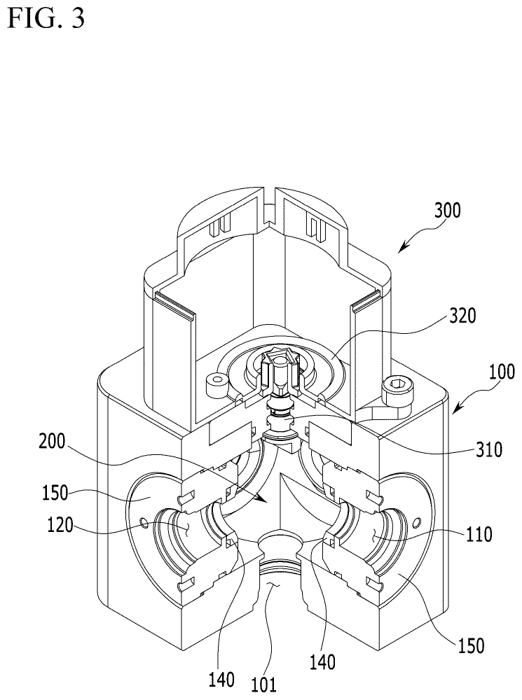

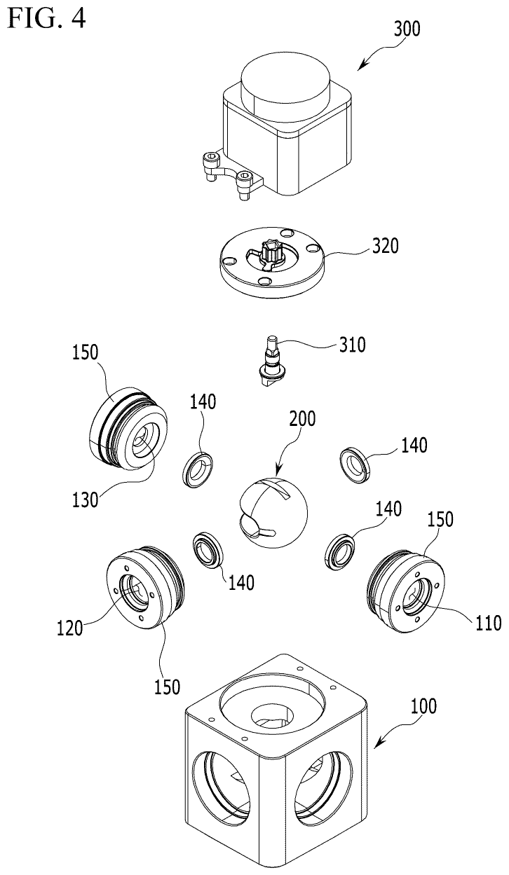

FIG. 1 and FIG. 2 are perspective views illustrating a configuration of a valve assembly according to an example. FIG. 3 is a partially cut-away perspective view illustrating a configuration of a valve assembly according to an example. Also, FIG. 4 is an exploded perspective view of a valve assembly according to an embodiment.

According to an embodiment, as shown in FIG. 1 to FIG. 4, a valve assembly may include a valve housing 100 in which a plurality of housing ports are formed, and a valve body 200 formed in a spherical shape and rotatably disposed within the valve housing 100.

The valve housing 100 has a mount space to accommodate the valve body 200, a lower or bottom housing port 101 (hereinafter “lower housing port”) is formed at the lower or bottom portion (e.g., hereinafter “lower portion”) of the valve housing 100, and a first housing port to a third housing port (110 to 130) are formed on side surfaces of the valve housing 100 arranged in a perimetric layout around the valve body. For example, the first to third housing ports (110 to 130) are formed on different lateral sides of the valve housing 100 in a spaced-apart arrangement surrounding the valve body. The lower housing port 101 may be positioned perpendicular to the planes where the first housing port 110 to the third housing port 130 are formed.

A driver 300 that generates a power to operate the valve body 200 may be installed on the upper part of the valve housing 100. The driver 300 may be implemented with an electric motor, a hydraulic pressure motor, a solenoid, or the like.

A driving bracket 320 is disposed at the lower part of the valve housing 100, and the driver 300 may be engaged with the valve housing 100 through the driving bracket 320.

The first housing port 110 to the third housing port 130 may be formed at predetermined intervals on side surfaces of the valve housing 100, in positions arranged around the valve housing 100. For example, the first housing port 110 and the second housing port 120 may be spaced apart by 90 degrees in the circumferential arrangement, and the second housing port 120 and the third housing port 130 may be spaced apart by 90 degrees, in the circumferential arrangement. Accordingly, the first housing port 110 and the third housing port 130 may be positioned 180 degrees apart.

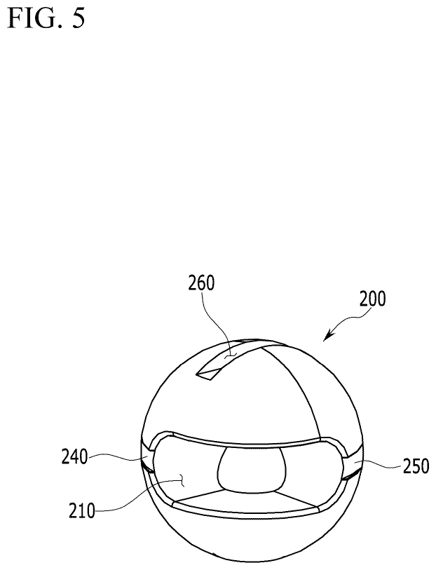

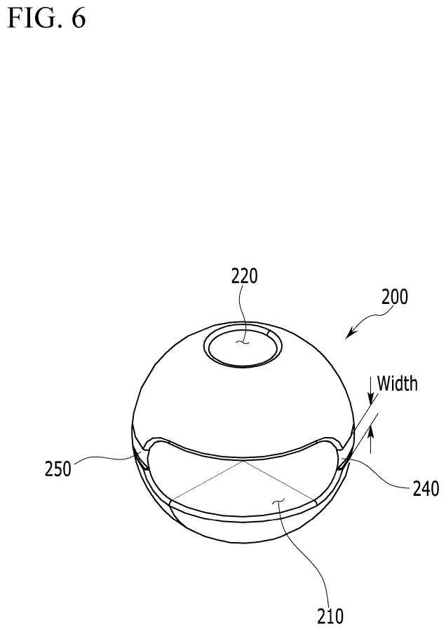

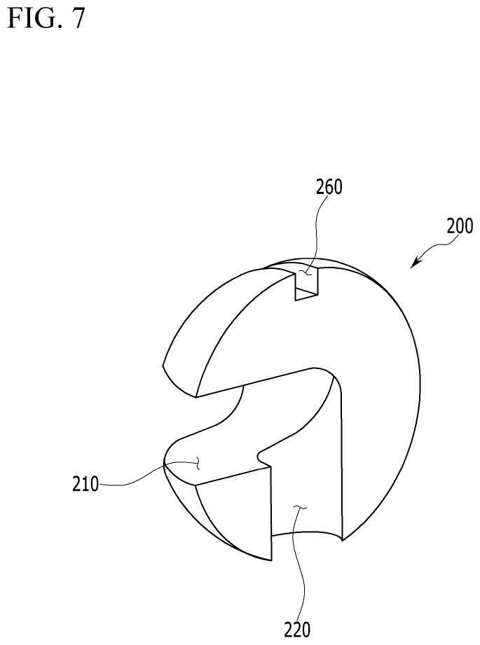

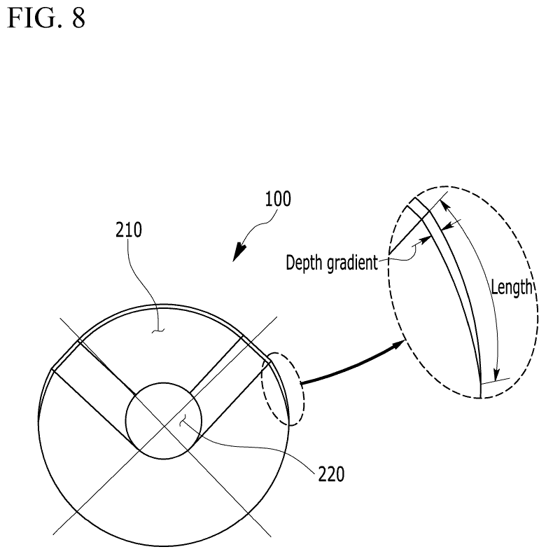

FIG. 5 and FIG. 6 are perspective views illustrating a configuration of a valve body according to an embodiment. FIG. 7 is a cutaway perspective view illustrating a configuration of a valve body according to an embodiment. Also, FIG. 8 is a cross-sectional view showing a configuration of a valve body according to an embodiment.

Referring to FIG. 5 to FIG. 8, the valve body 200 may be rotatably mounted in the mount space of the valve housing 100, be constantly and fluidly connected to the lower housing port 101 of the valve housing 100, and be selectively and fluidly connected to the first housing port 110 to the third housing port 130 of the valve housing 100.

The valve body 200 may be formed in a generally spherical shape and may include a lower or bottom body port (hereinafter “a lower body port) 220 through which an operating fluid (e.g., a refrigerant) flows in and out, a side body port 210 fluidly connected to the lower body port 220 and through which the operating fluid flows in and out, and a first expansion groove 240 and a second expansion groove 250 formed adjacent to the side body port 210 and through which the operating fluid expands and is discharged.

The lower body port 220 may be formed in the lower center of the valve body 200, and the operating fluid may be inflowed into the valve body 200 through the lower body port 220, or the operating fluid may be discharged from the valve body 200.

A shaft groove 260 may be formed on the upper part of the valve body 200, and the shaft groove 260 may be coupled to the drive shaft 310 of the driver 300.

The side body port 210 may be fluidly connected to the lower body port 220 and be formed at the center of the side of the valve body 200. In other words, the side body port 210 may be formed vertically with respect to the lower body port 220.

The side body port 210 may be formed to a predetermined length along the circumferential direction. The circumferential direction length of the side body port 210 may be formed to correspond to the sum of the circumferential direction lengths of the first housing port 110 and the second housing port 120, and the circumferential direction lengths of the second housing port 120 and the third housing port 130.

For example, the side body port 210 may have a cross-section formed in a fan shape and may include a first side, a second side, and an arc formed by the first side and the second side. At this time, the length of the arc (or an angle of the arc) formed by the first side and the second side may be formed to correspond to the circumferential direction length (or an angle) formed by the first housing port 110 and the second housing port 120. With this configuration, the operating fluid inflowing into the side body port 210 may be simultaneously discharged to two housing ports (e.g., the first housing port 110 and the second housing port 120).

The first expansion groove 240 and the second expansion groove 250 may be formed to have a length equal to a predetermined angle along the rotating direction of the valve body 200, a predetermined width in a direction perpendicular to the rotating direction of the valve body 200, and a predetermined depth gradient along the length of the expansion groove.

In an embodiment, the depth gradient of the first expansion groove 240 and the second expansion groove 250 may mean a change in the depth in a direction (referred to as a depth direction, as needed) perpendicular to the length direction of the first expansion groove 240 and the second expansion groove 250 when the first expansion groove 240 and the second expansion groove 250 are formed with the length equal to the predetermined angle along the rotating direction of the valve body 200.

The large depth gradient may mean that the first expansion groove 240 and the second expansion groove 250 are formed to deepen rapidly along the rotating direction of the valve body 200, and the small depth gradient may mean that the first expansion groove 240 and the second expansion groove 250 are formed to deepen gently along the rotating direction of the valve body 200.

In other words, the first expansion groove 240 and the second expansion groove 250 may be formed to have a predetermined length, a predetermined width, and a predetermined depth gradient.

The first expansion groove 240 and the second expansion groove 250 may be formed adjacent to the side body port 210 and be formed to face each other with the side body port 210 as the center. In other words, the first expansion groove 240 may be formed adjacent to one side of the circumferential direction of the side body port 210, and the second expansion groove 250 may be formed adjacent to the other side of the circumferential direction of the side body port 210.

The first expansion groove 240 and the second expansion groove 250 may have the same shape. In this embodiment, the first expansion groove 240 and the second expansion groove 250 may be formed symmetrically to each other along the circumferential direction (or the rotating direction) of the valve body 200, with the side body port 210 as a reference. In other words, the lengths, the widths, and the depth gradients of the first expansion groove 240 and the second expansion groove 250 may be formed identically. Since the first expansion groove 240 and the second expansion groove 250 are formed with the same shape, the function of two identical expansion valves may be performed through one valve assembly.

In another embodiment, the first expansion groove 240 and the second expansion groove 250 may have different shapes. In this embodiment, the first expansion groove 240 and the second expansion groove 250 may be formed asymmetrically along the circumferential direction (or the rotating direction) of the valve body 200, with the side body port 210 as a reference. For example, at least one of the length, the width, or the depth gradient of the first expansion groove 240 may be formed differently from the length, the width, and the depth gradient of the second expansion groove 250. By forming the first expansion groove 240 and the second expansion groove 250 with the different shapes (e.g., by forming at least one of the length, the width, and/or the depth gradient of the first expansion groove 240 and the second expansion groove 250 differently), the functions of two different expansion valves may be performed through one valve assembly.

Meanwhile, a valve sheet 140 and a valve supporter 150 may be provided between the first housing port 110 to the third housing port 130 of the valve housing 100 and the valve body 200, respectively, and the first housing port 110 to the third housing port 130 may be fluidly connected to the side body port 210 of the valve body 200 through the valve sheet 140 and the valve supporter 150.

The valve sheet 140 may be formed in a shape of an approximately circular plate with a hollow center and be provided in contact with the exterior surface of the valve body 200. The valve sheet 140 may rotatably support the valve body 200. The support surface of the valve sheet 140 facing the valve body 200 may be formed into a partially spherical shape corresponding to the valve body 200.

The valve supporter 150 may be provided on the outer side of the valve sheet 140 in the radial direction and be formed into an approximately cylinder shape with a hollow center. In an embodiment, the first housing port 110 to the third housing port 130 may each be formed in the valve supporter 150.

In an embodiment, the lower body port 220 may be constantly and fluidly connected to the lower housing port 101 depending on the rotation of the valve body 200. Also, depending on the rotation of the valve body 200, the side body port 210 may be selectively and fluidly connected to at least one of the first housing port 110, the second housing port 120, or the third housing port 130, and the side body port 210 may be selectively and fluidly connected to any one of the first housing port 110 to the third housing port 130 via one of the first expansion groove 240 or the second expansion groove 250.

Hereinafter, the operation of the valve assembly according to an embodiment is described in detail with reference to attached drawings.

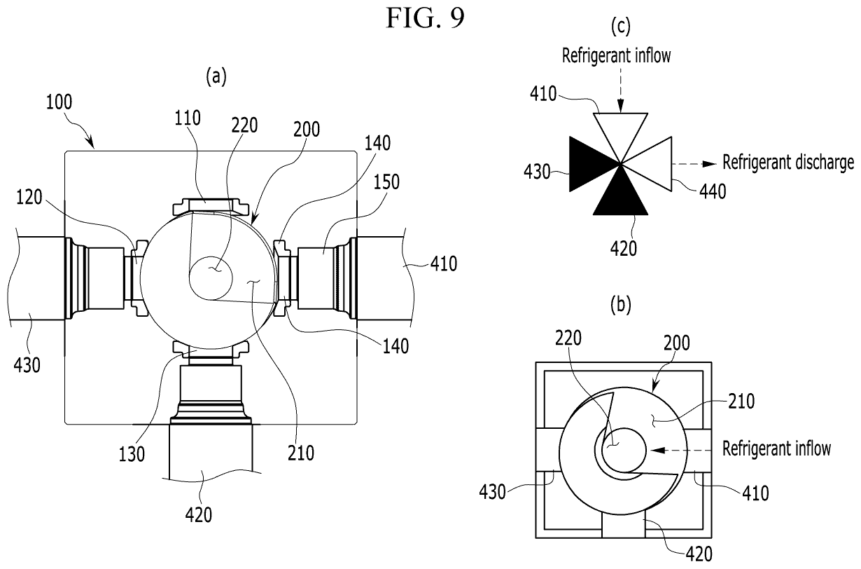

FIG. 9 to FIG. 13 are diagrams illustrating operation states of a valve assembly according to an example.

Referring to FIG. 9 to FIG. 13, according to an embodiment, the valve assembly may selectively operate in one of a first mode to a sixth mode by rotating the valve body 200 depending on the operation mode of the heat pump system.

According to an embodiment, a heat pump system may include a plurality of refrigerant lines through which an operating fluid (e.g., a refrigerant) flows. For example, the plurality of refrigerant lines may include a first refrigerant line 410, a second refrigerant line 420, a third refrigerant line 430, and a fourth refrigerant line 440.

The first refrigerant line 410 to the third refrigerant line 430 may be fluidly connected to the first housing port 110 to the third housing port 130 of the valve housing 100, respectively. The first refrigerant line 410 to the third refrigerant line 430 may be sequentially arranged at a predetermined angle apart along the perimeter of the valve housing 100.

Also, the fourth refrigerant line 440 may be located at the lower part of the valve housing 100 of the valve assembly. The fourth refrigerant line 440 may be constantly and fluidly connected to the lower body port 220 of the valve body 200 through the lower housing port 101 of the valve housing 100.

In other words, depending on the rotation of the valve body 200, the lower body port 220 of the valve body 200 may be constantly and fluidly connected to the fourth refrigerant line 440 through the lower housing port 101, and the side body port 210 of the valve body 200 may be selectively and fluidly connected to at least one of the first refrigerant line 410, the second refrigerant line 420, or the third refrigerant line 430 through the first housing port 110 to the third housing port 130.

The first mode may be a mode in which the refrigerant inflowing into the first refrigerant line 410 is discharged into the fourth refrigerant line 440. The second mode may be a mode in which some of the refrigerant that flows into the first refrigerant line 410 expands and is discharged into the second refrigerant line 420, and the remaining refrigerant that flows into the first refrigerant line 410 is discharged into the fourth refrigerant line 440. The third mode may be a mode in which the refrigerant flowing into the first refrigerant line 410 is discharged into the second refrigerant line 420 and the fourth refrigerant line 440. The fourth mode may be a mode in which some of the refrigerant flowing into the third refrigerant line 430 is expanded and discharged into the second refrigerant line 420, and the remaining refrigerant flowing into the third refrigerant line 430 is discharged into the fourth refrigerant line 440. The fifth mode may be a mode in which the refrigerant flowing into the third refrigerant line 430 is discharged to the second refrigerant line 420 and the fourth refrigerant line 440. Also, the sixth mode may be a mode in which the refrigerant flowing into the third refrigerant line 430 is discharged into the fourth refrigerant line 440.

The first mode and the sixth mode may be modes in which the refrigerant inflowing into the valve assembly is discharged into one refrigerant line. The second mode and fourth mode may be modes in which some of the refrigerant inflowing into the valve assembly is expanded and discharged into one refrigerant line, and the remaining refrigerant is discharged into another refrigerant line. Also, the third mode and fifth mode may be modes in which the refrigerant inflowing into the valve assembly is discharged to two refrigerant lines.

The first mode may be a state where the valve body 200 is positioned at the reference position, the second mode may be a state where the valve body 200 is rotated from the reference position to a first predetermined angle (e.g., 45 degrees) in a predetermined direction (e.g., a clockwise direction), the third mode may be a state where the valve body 200 is rotated from the reference position to a second predetermined angle (e.g., 90 degrees) in a predetermined direction (e.g., a clockwise direction), the fourth mode may be a state where the valve body 200 is rotated a third predetermined angle (e.g., 180 degrees) in a predetermined direction (e.g., a clockwise direction) from the reference position, the fifth mode may be a state where the valve body 200 is rotated a fourth predetermined angle (e.g., 225 degrees) in a predetermined direction (e.g., a clockwise direction) from the reference position, and the sixth mode may be a state where the valve body 200 is rotated a fifth predetermined angle (e.g., 270 degrees) in a predetermined direction (e.g., a clockwise direction) from the reference position.

At this time, the second predetermined angle may be larger than the first predetermined angle, the third predetermined angle may be larger than the second predetermined angle, the fourth predetermined angle may be larger than the third predetermined angle, and the fifth predetermined angle may be larger than the fourth predetermined angle.

Referring to FIG. 9, in a first mode where the valve body 200 is positioned in the reference position, the first refrigerant line 410 may be fluidly connected to the fourth refrigerant line 440 through the first housing port 110 of the valve housing 100, the side body port 210 of the valve body 200, the lower body port 220, and the fourth housing port of the valve housing 100.

At this time, the second housing port 120 and the third housing port 130 of the valve housing 100 may be blocked by the valve body 200, and the second refrigerant line 420 and the third refrigerant line 430 may also be blocked.

Accordingly, the refrigerant inflowing through the first refrigerant line 410 may be discharged to the fourth refrigerant line 440 through the first housing port 110 of the valve housing 100, the side body port 210 of the valve body 200, the lower body port 220, and the fourth housing port of the valve housing 100.

In other words, in the first mode, the refrigerant that flows into the valve assembly through one inlet (e.g., the first refrigerant line 410) may be discharged only through one outlet (e.g., the fourth refrigerant line 440), and at this time, the refrigerant may be discharged without being expanded.

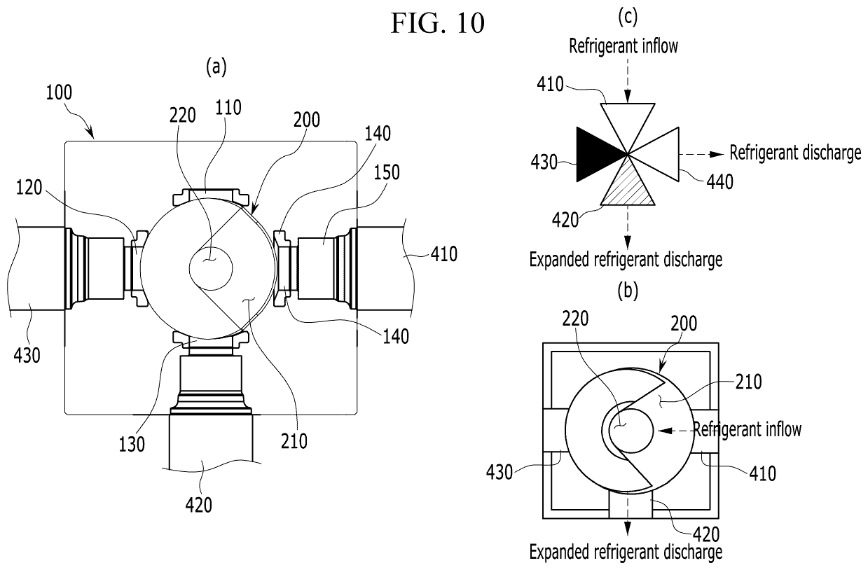

Referring to FIG. 10, in the second mode, where the valve body 200 has rotated by the first predetermined angle in the predetermined direction (e.g., the clockwise direction) from the reference position, the first refrigerant line 410 may be fluidly connected to the fourth refrigerant line 440 through the first housing port 110 of the valve housing 100, the side body port 210 of the valve body 200, the lower body port 220, and the lower housing port 101 of the valve housing 100. Simultaneously, the first refrigerant line 410 may be fluidly connected to the second refrigerant line 420 through the first housing port 110 of the valve housing 100, the side body port 210 of the valve body 200, the first expansion groove 240, and the second housing port 120 of the valve housing 100.

At this time, the third housing port 130 of the valve housing 100 may be blocked by the valve body 200, and the third refrigerant line 430 may also be blocked.

Accordingly, some of the refrigerant inflowing into the first refrigerant line 410 may be discharged into the fourth refrigerant line 440 through the first housing port 110 of the valve housing 100, the side body port 210 of the valve body 200, the lower body port 220, and the fourth housing port of the valve housing 100. Simultaneously, the remaining refrigerant inflowing into the first refrigerant line 410 may be discharged into the second refrigerant line 420 through the first housing port 110 of the valve housing 100, the side body port 210 of the valve body 200, the first expansion groove 240, and the second housing port 120 of the valve housing 100. At this time, the refrigerant may be expanded while passing through the first expansion groove 240 and be discharged into the second refrigerant line 420.

In other words, in the second mode, the refrigerant that flows into the valve assembly through one inlet (e.g., the first refrigerant line 410) may be discharged to two outlets (e.g., the second refrigerant line 420 and the fourth refrigerant line 440), and at this time, some of the refrigerant may be expanded and then discharged, and the remaining refrigerant may be discharged without being expanded.

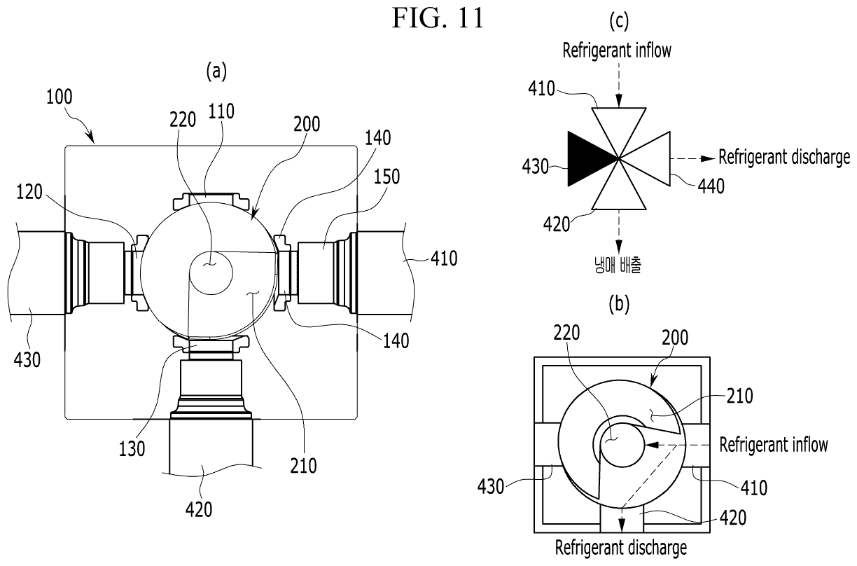

Referring to FIG. 11, in a third mode where the valve body 200 is rotated by the second predetermined angle in the predetermined direction (e.g., the clockwise direction) from the reference position, the first refrigerant line 410 may be fluidly connected to the fourth refrigerant line 440 through the first housing port 110 of the valve housing 100, the side body port 210 and lower body port 220 of the valve body 200, and the lower housing port 101 of the valve housing 100. Simultaneously, the first refrigerant line 410 may be fluidly connected to the second refrigerant line 420 through the first housing port 110 of the valve housing 100, the side body port 210 of the valve body 200, and the second housing port 120 of the valve housing 100.

At this time, the first housing port 110 of the valve housing 100 may be blocked by the valve body 200, and the first refrigerant line 410 may also be blocked.

Accordingly, some of the refrigerant inflowing into the first refrigerant line 410 may be discharged into the fourth refrigerant line 440 through the first housing port 110 of the valve housing 100, the side body port 210 and lower body port 220 of the valve body 200, and the lower housing port 101 of the valve housing 100. Simultaneously, the remaining refrigerant inflowing into the first refrigerant line 410 may be discharged into the second refrigerant line 420 through the first housing port 110 of the valve housing 100, the side body port 210 of the valve body 200, and the second housing port 120 of the valve housing 100.

In other words, in the third mode, the refrigerant that flows into the valve assembly through one inlet (e.g., first refrigerant line 410) may be discharged to two outlets (e.g., the second refrigerant line 420 and the fourth refrigerant line 440), and at this time, the refrigerant may be discharged without being expanded.

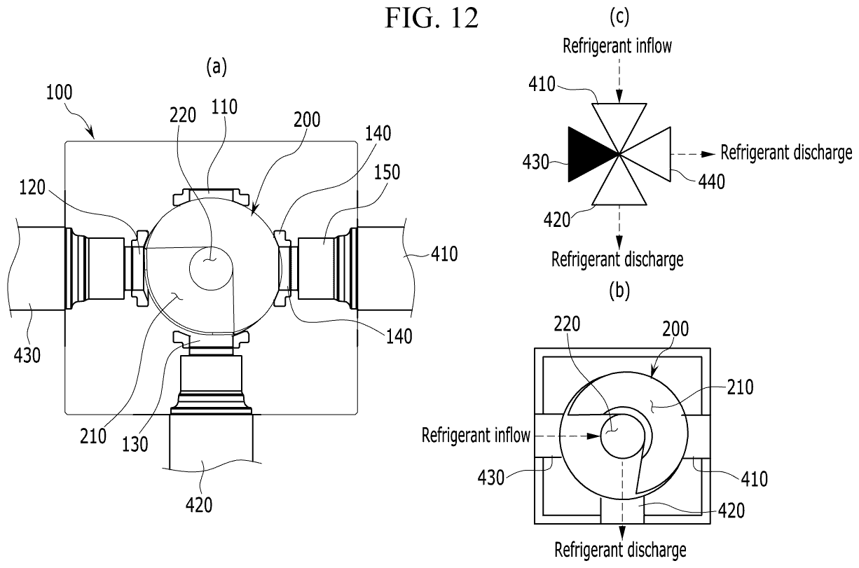

Referring to FIG. 12, in a fourth mode where the valve body 200 is rotated by the third predetermined angle in the predetermined direction (e.g., the clockwise direction) from the reference position, the third refrigerant line 430 may be fluidly connected to the fourth refrigerant line 440 through the third housing port 130 of the valve housing 100, the side body port 210 and lower body port 220 of the valve body 200, and the lower housing port 101 of the valve housing 100. Simultaneously, the third refrigerant line 430 may be fluidly connected to the second refrigerant line 420 via the third housing port 130 of the valve housing 100, the side body port 210 of the valve body 200, and the second housing port 120 of the valve housing 100.

At this time, the first housing port 110 of the valve housing 100 may be blocked by the valve body 200, and the first refrigerant line 410 may also be blocked.

Accordingly, some of the refrigerant inflowing into the third refrigerant line 430 may be discharged into the fourth refrigerant line 440 through the third housing port 130 of the valve housing 100, the side body port 210 and lower body port 220 of the valve body 200, and the lower housing port 101 of the valve housing 100. Simultaneously, the remaining refrigerant inflowing into the third refrigerant line 430 may be discharged into the second refrigerant line 420 through the third housing port 130 of the valve housing 100, the side body port 210 of the valve body 200, and the second housing port 120 of the valve housing 100.

In other words, in the fourth mode, the refrigerant that flows into the valve assembly through one inlet (the third refrigerant line 430) may be discharged to two outlets (e.g., the second refrigerant line 420 and the fourth refrigerant line 440), and at this time, the refrigerant may be discharged without being expanded.

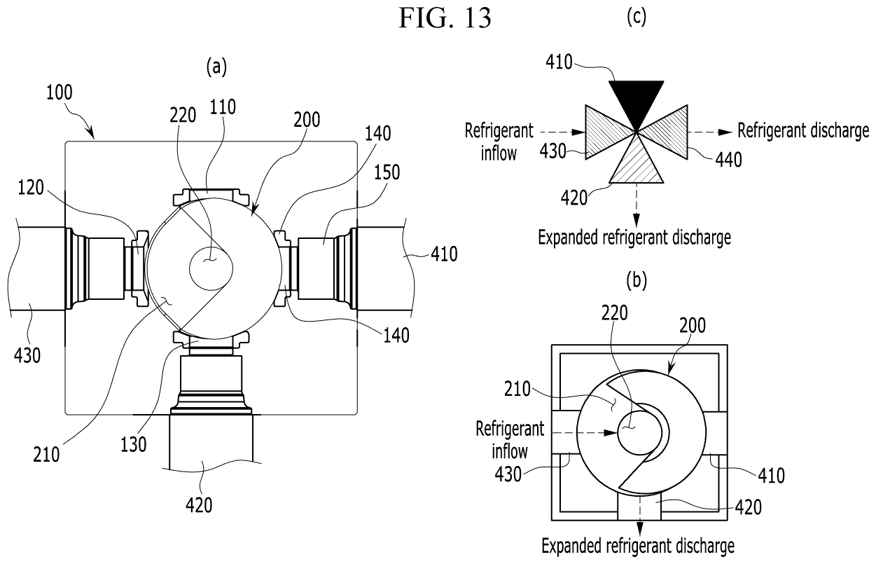

Referring to FIG. 13, in the fifth mode where the valve body 200 is rotated by the fourth predetermined angle in the predetermined direction (e.g., the clockwise direction) from the reference position, the third refrigerant line 430 may be fluidly connected to the fourth refrigerant line 440 through the third housing port 130 of the valve housing 100, the side body port 210 and lower body port 220 of the valve body 200, and the lower housing port 101 of the valve housing 100. Simultaneously, the third refrigerant line 430 may be fluidly connected to the second refrigerant line 420 through the third housing port 130 of the valve housing 100, the side body port 210 of the valve body 200, the second expansion groove 250, and the second housing port 120 of the valve housing 100.

At this time, the first housing port 110 of the valve housing 100 may be blocked by the valve body 200, and the first refrigerant line 410 can also be blocked.

Accordingly, some of the refrigerant inflowing into the third refrigerant line 430 may be discharged into the fourth refrigerant line 440 through the third housing port 130 of the valve housing 100, the side body port 210 and lower body port 220 of the valve body 200, and the lower housing port 101 of the valve housing 100. Simultaneously, the remaining refrigerant inflowing into the third refrigerant line 430 may be discharged into the second refrigerant line 420 through the third housing port 130 of the valve housing 100, the side body port 210 of the valve body 200, the second expansion groove 250, and the second housing port 120 of the valve housing 100. At this time, the refrigerant may be expanded while passing through the second expansion groove 250 and be discharged into the second refrigerant line 420.

In other words, in the fifth mode, the refrigerant flowing into the valve assembly through one inlet (e.g., the third refrigerant line 430) may be discharged to two outlets (e.g., the second refrigerant line 420 and the fourth refrigerant line 440), and at this time, some of the refrigerant may be expanded and the remaining refrigerant may be discharged without being expanded.

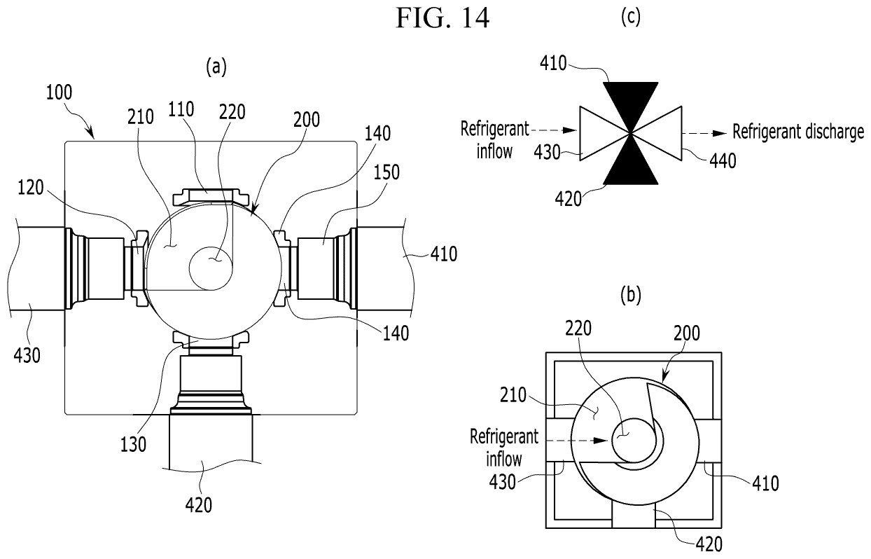

Referring to FIG. 14, in the sixth mode where the valve body 200 is rotated by the fifth predetermined angle in the predetermined direction (e.g., the clockwise direction) from the reference position, the third refrigerant line 430 may be fluidly connected to the fourth refrigerant line 440 through the third housing port 130 of the valve housing 100, the side body port 210 and lower body port 220 of the valve body 200, and the lower housing port 101 of the valve housing 100.

At this time, the first housing port 110 and the second housing port 120 of the valve housing 100 may be blocked by the valve body 200, and the first refrigerant line 410 and the second refrigerant line 420 may also be blocked.

Accordingly, the refrigerant inflowing through the third refrigerant line 430 may be discharged to the fourth refrigerant line 440 through the third housing port 130 of the valve housing 100, the side body port 210 and lower body port 220 of the valve body 200, and the lower housing port 101 of the valve housing 100.

In other words, in the sixth mode, the refrigerant that flows into the valve assembly through one inlet (e.g., the third refrigerant line 430) may be discharged through one outlet (e.g., the fourth refrigerant line 440), and at this time, the refrigerant may be discharged without being expanded.

According to the valve assembly according to an embodiment as described above, the discharge path of the refrigerant inflowing into one valve assembly may be diversified, and the function of the expansion valve may be implemented as needed. With this configuration, the structure of the heat pump system to which the valve assembly is applied may be simplified and a manufacturing cost may be reduced.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: valve housing
101: lower housing port
110: first housing port
120: second housing port
130: third housing port
140: valve sheet
150: valve supporter
200: valve body
210: side body port
220: lower body port
240: first expansion groove
250: second expansion groove
260: shaft groove
300: driver
310: drive shaft
320: driving bracket
410: first refrigerant line
420: second refrigerant line
430: third refrigerant line
440: fourth refrigerant line

What is claimed is:

1. A valve assembly comprising:
a valve housing including:
a bottom housing port, and
a first housing port, a second housing port and a third housing port, which are formed on side surfaces of the valve housing; and
a valve body rotatably disposed an inside of the valve housing and including:
a bottom body port,
a side body port fluidly connected to the bottom body port, and
a first expansion groove and a second expansion groove formed adjacent to the side body port,
wherein the first housing port, the second housing port, and the third housing port are arranged in a circumferential layout around the valve body,
wherein the bottom body port and the bottom housing port are constantly and fluidly connected to each other, and
wherein based on rotation of the valve body, the side body port is selectively and fluidly connected to at least one of the first housing port, the second housing port or the third housing port, and the side body port is selectively and fluidly connected to one of the first housing port, the second housing port and the third housing port through the first expansion groove or the second expansion groove.

2. The valve assembly of claim 1, wherein:
the bottom body port is formed at a bottom part of the valve body,
the side body port is arranged perpendicular to the bottom body port and is formed along a circumferential direction of the valve body,
the first expansion groove is formed adjacent to a first side of the side body port of the circumferential direction, and
the second expansion groove is formed adjacent to a second side of the side body port of the circumferential direction.

3. The valve assembly of claim 2, wherein:
a circumferential direction length of the side body port is formed to correspond to a sum of circumferential direction lengths of the first housing port and the second housing port, and circumferential direction lengths of the second housing port and the third housing port.

4. The valve assembly of claim 2, wherein:
the first expansion groove and the second expansion groove have the same shape.

5. The valve assembly of claim 4, wherein:
the first expansion groove and the second expansion groove are formed to have identical lengths, widths, and depth gradients.

6. The valve assembly of claim 1, wherein:
the first housing port and the second housing port are arranged at a predetermined angle in a circumferential direction of the valve body, and
the second housing port and the third housing port are arranged at a predetermined angle in the circumferential direction.

7. The valve assembly of claim 6, wherein:
the predetermined angle by which the first housing port and the second housing port are spaced apart in the circumferential direction is equal to the predetermined angle by which the second housing port and the third housing port are spaced apart in the circumferential direction.

8. The valve assembly of claim 7, wherein:
the predetermined angle by which the first housing port and the second housing port are spaced apart in the circumferential direction, and the predetermined angle by which the second housing port and the third housing port are spaced apart in the circumferential direction, are each 90 degrees.

9. A heat pump system comprising:
a valve housing including:
a bottom housing port, and
a first housing port, a second housing port, a third housing port, and a fourth housing port, which are respectively formed on side surfaces of the valve housing ;
a valve body rotatably disposed within the valve housing and including:
a bottom body port,
a side body port fluidly connected to the bottom body port, and
a first expansion groove and a second expansion groove formed adjacent to the side body port;
a first refrigerant line, a second refrigerant line, and a third refrigerant line, which are fluidly connected to the first housing port, the second housing port and the third housing port, respectively; and
a fourth refrigerant line fluidly connected to the bottom housing port of the valve housing,
wherein the side body port is selectively and fluidly connected to at least one of: the first housing port and the first refrigerant line; the second housing port and the second refrigerant line; or the third housing port and the third refrigerant line, and
wherein the bottom body port is constantly and fluidly connected to the bottom housing port and the fourth refrigerant line.

10. The heat pump system of claim 9, wherein:
one of a first mode, a second mode, a third mode, a fourth mode, a fifth mode and a sixth mode is determined based on rotation of the valve body,
the first mode is a mode in which refrigerant flowing into the first refrigerant line is discharged into the fourth refrigerant line,
the second mode is a mode in which some of the refrigerant flowing into the first refrigerant line is expanded and discharged into the second refrigerant line, and the remaining refrigerant flowing into the first refrigerant line is discharged into the fourth refrigerant line,
the third mode is a mode in which the refrigerant flowing into the first refrigerant line is discharged to the second refrigerant line and the fourth refrigerant line,
the fourth mode is a mode in which some of the refrigerant flowing into the third refrigerant line is expanded and discharged into the second refrigerant line, and the remaining refrigerant flowing into the third refrigerant line is discharged into the fourth refrigerant line,
the fifth mode is a mode in which the refrigerant flowing into the third refrigerant line is discharged to the second refrigerant line and the fourth refrigerant line, and
the sixth mode is a mode in which the refrigerant flowing into the third refrigerant line is discharged into the fourth refrigerant line.

11. The heat pump system of claim 10, wherein:
the valve body is positioned at a reference position in the first mode,
the valve body is rotated by a first predetermined angle in a predetermined direction from the reference position in the second mode,
the valve body is rotated by a second predetermined angle in a predetermined direction from the reference position in the third mode,
the valve body is rotated by a third predetermined angle in a predetermined direction from the reference position in the fourth mode,
the valve body is rotated by a fourth predetermined angle in a predetermined direction from the reference position in the fifth mode, and
the valve body is rotated by a fifth predetermined angle in a predetermined direction from the reference position in the sixth mode.

12. The heat pump system of claim 10, wherein:
in the first mode,
the first refrigerant line is fluidly connected to the fourth refrigerant line through the first housing port, the side body port, the bottom body port, and the fourth housing port, and
the refrigerant flowing through the first refrigerant line is discharged to the fourth refrigerant line.

13. The heat pump system of claim 10, wherein:
in the second mode,
the first refrigerant line is fluidly connected to the fourth refrigerant line through the first housing port, the side body port, the bottom body port, and the fourth housing port, and
the first refrigerant line is fluidly connected to the second refrigerant line through the first housing port, the side body port, the first expansion groove, and the second housing port, and
a portion of the refrigerant that inflows into the first refrigerant line is discharged into the fourth refrigerant line, and
the remaining refrigerant that flows into the first refrigerant line expands through the first expansion groove and is discharged into the second refrigerant line.

14. The heat pump system of claim 10, wherein:
in the third mode,
the first refrigerant line is fluidly connected to the fourth refrigerant line through the first housing port, the side body port, the bottom body port, and the bottom housing port,
the first refrigerant line is fluidly connected to the second refrigerant line through the first housing port, the side body port, and the second housing port,
a portion of the refrigerant that inflows into the first refrigerant line is discharged into the fourth refrigerant line, and
the remaining refrigerant that flows into the first refrigerant line is discharged into the second refrigerant line.

15. The heat pump system of claim 10, wherein:
in the fourth mode,
the third refrigerant line is fluidly connected to the fourth refrigerant line through the third housing port, the side body port, the bottom body port, and the bottom housing port,
the third refrigerant line is fluidly connected to the second refrigerant line through the third housing port, the side body port, and the second housing port,
a portion of the refrigerant that flows into the third refrigerant line is discharged into the fourth refrigerant line, and
the remaining refrigerant that flows into the third refrigerant line is discharged into the second refrigerant line.

16. The heat pump system of claim 10, wherein:
in the fifth mode,
the third refrigerant line is fluidly connected to the fourth refrigerant line through the third housing port, the side body port, the bottom body port, and the bottom housing port,
the third refrigerant line is fluidly connected to the second refrigerant line through the third housing port, the side body port, the second expansion groove, and the second housing port,
a portion of the refrigerant that inflows into the second refrigerant line is discharged into the fourth refrigerant line, and
the remaining refrigerant flowing into the second refrigerant line expands through the second expansion groove and is discharged into the second refrigerant line.

17. The heat pump system of claim 10, wherein:
in the sixth mode,
the third refrigerant line is fluidly connected to the fourth refrigerant line through the third housing port, the side body port, the bottom body port, and the bottom housing port, and
the refrigerant flowing into the third refrigerant line is discharged into the fourth refrigerant line.

18. A valve assembly for a heat pump system, comprising:
a valve housing including:
a bottom housing port, and
a first housing port, a second housing port and a third housing port, which are respectively formed on side surfaces of the valve housing; and
a valve body rotatably disposed within the valve housing and including:
a bottom body port,
a side body port fluidly connected to the bottom body port, and
a first expansion groove and a second expansion groove formed adjacent to the side body port,
wherein the bottom body port and the bottom housing port are constantly and fluidly connected to each other, and
wherein based on rotation of the valve body, the side body port is selectively and fluidly connected to at least one of the first housing port, the second housing port or the third housing port, and the side body port is selectively and fluidly connected to one of the first housing port, the second housing port and the third housing port through the first expansion groove or the second expansion groove.

19. The valve assembly of claim 18, wherein:
the first expansion groove is formed adjacent to a first side of the side body port, and
the second expansion groove is formed adjacent to a second side of the side body port.

20. The valve assembly of claim 19, wherein:
the first housing port and the second housing port are arranged at a first predetermined angle, and
the second housing port and the third housing port are arranged at a second predetermined angle.
